(19) United States
(12) Patent Application Publication
(10) Pub. No.: US 2022/0187908 A1
(43) Pub. Date: Jun. 16, 2022

(54) Nystagmus vision correction

(71) Applicant: Adam Melhem, Kafr Yasif (IL)

(72) Inventor: Adam Melhem, Kafr Yasif (IL)

(21) Appl. No.: 17/142,335

(22) Filed: May 2, 2021

(30) Foreign Application Priority Data
Dec. 15, 2020 (CN) 17142335
Dec. 15, 2020 (EU) 17142335
Dec. 15, 2020 (US) 17142335

(51) Int. Cl. G06F 3/01; G02C 7/06

(52) U.S. Cl. CPC G06F 3/013; G02C 2202/24; G02C 7/061

(57) ABSTRACT

The invention is intended to solve the Nystagmus vision issue, it will solve those issues by using two cameras that replace the patient eyes to be the first to capture the vision then those cameras display the vision to the real eyes using VR display that the patient is wearing, inside the VR glasses there would be another night vision two internal cameras that intended to capture and track the eyes iris movements, so that two external cameras capture the real world vision and another two internal night vision cameras capture the eyes iris positions, and display VR that display the corrected vision to each eye of the patient, the device has software that get the external two cameras vision then correct them based on the other two internal cameras eyes iris positions, so that the vision for each eye would be displayed on the VR screen after been fixed.

### FIELD

The present application relates to a google device with a front two cameras and two internal cameras that are mounted on VR screen.

### BACKGROUND

The invention is intended to solve the Nystagmus vision issue, since the patients may suffer from both Nystagmus and other vision issues like myopia and hyperopia it is a challenge to cure the patient eyes and almost impossible, so that this electronic based solution can solve this issue by replacing the original eyes functionality with electronic components consist of cameras and VR screen.

### DETAILED DESCRIPTION

In the following detailed description, the over all device consist of four cameras and VR display , two cameras are externals and two cameras are internal and the VR screen is on front of the user eyes to display the content, the external two cameras are used as a googles to capture the real world view and the internal two cameras are used to track the user eyes iris positions and movements, the device will have software that takes the real world view and enhance it based on the internal two cameras captured iris positions and then display the new view on the VR screen, so that assuming that the user has left eye looking to the extreme left and right eye looking to the extreme right (unormal behaviour of eyes), the in this case the internal two cameras will capture the iris positions and transmit the data to the device software, then the software will take the real world streaming video and enhance it so that eventhought the two eyes of the user are not looking in the correct direction the displayed view in the VR are corrected in such a way that they compensate on the eyes position error, for example assuming the user eyes are flipped up down in a wrong way (flipped horizontally), then the device software will take the external two cameras real world streaming video and flip it exactly in the opposite of the eyes looking direction that is it will flip the video down up as a form of video image looking correction and then this enhanced new video would be displayed to the user eyes through the VR display.

### SUMMARY

By providing a device that can enhance the real world view to fit with abnormal patient eyes positions it is possible to make it possible for the patient to see normally.

The device is doing that by two external cameras and two internal eyes position tracking cameras, those inputs then enhanced by a device software and then display adapted corrected video view in the VR screen to the patient.

So that using this device would solve Nystagmus vision patients issue and fix their vision.

1. A device that consists of two external cameras, and night vision two internal cameras intended to track the eyes iris movements and implemented inside a VR display glasses in which all those components are controlled by a software algorithm that fix the patient eyes vision based on each eye misfunctioning condition due to Nystagmus and other vision issues like myopia and hyperopia.

2. The two external cameras in claim 1 are positioned each exactly on the same position as the patient each eye position accordingly, however on top outside of the VR display glasses yet in the external side not the internal side which intended to display images to the patient eyes.

3. The two internal cameras in claim 1 are positioned each exactly on the same position as the patient each eye position accordingly yet a bit higher than the iris level (to avoid the vision sight blocking), they are implemented inside on top of the VR display glasses internal side which intended to display images to the patient eyes not in the external side.

4. The two internal cameras in claim 1 are intended to provide track indication of the eyes iris position.

5. The two external cameras in claim 1 are intended to capture the real-world original vision view to be provided as an image data input to the device software.

6. The VR display glasses in claim 1 is intended to display the corrected vision images by the software in a wide vision angle large enough to handle the abnormal iris movements and sight out of control pointing.

7. The device software mentioned in claim 1 that get the two external cameras images as an input and the two internal night vision cameras as an input (to track the eyes iris movements), and then enhance and modify them based on the eyes iris positions angle and eyes sight issues (like myopia and hyperopia) to fit with the patient eyes vision issues (correct vision angle and focusing the images on the patient eyes retina instead of in front or in after it by modifying the original vision photos to fit with each eye condition in real time), and then display the enhanced images on the VR display glasses to the patient eyes.

8. The external two cameras in claim 1 support night vision and zoom in and out and can be standard cameras or VR cameras.

9. The software in claim 1 can also display textual information on top of the displayed images, and can capture photo snapshots and video recording store them in SD card and also online internet video sharing them as a files and a video stream, and image quality enhancements.

10. The device would support Bluetooth connection, to be used as a connection between the device and patient smartphone, which would have another smartphone software that intended to provide control over the device features and configurations.
